(19) United States
(12) Patent Application Publication
(10) Pub. No.: US 2025/0330979 A1
(43) Pub. Date: Oct. 23, 2025

(54) LOWER LATENCY WITH ENERGY EFFICIENT SCHEDULING

(71) Applicant: QUALCOMM Incorporated, San Diego, CA (US)

(72) Inventors: Diana MAAMARI, San Diego, CA (US); Gabi SARKIS, San Diego, CA (US); Weimin DUAN, San Diego, CA (US); Kangqi LIU, San Diego, CA (US); Prashanth Haridas HANDE, San Diego, CA (US)

(21) Appl. No.: 18/644,037

(22) Filed: Apr. 23, 2024

(51) Int. Cl. H04W 72/1273; H04L 5/00; H04W 72/21

(52) U.S. Cl. CPC H04W 72/1273; H04L 5/0053; H04W 72/21

(57) ABSTRACT

Method and apparatus for a lower latency with energy efficient scheduling. The apparatus receives a configuration including at least an indication to operate in a reduced peak throughput state and a plurality of PUCCH resources. The apparatus selects a first PUCCH resource from the plurality of PUCCH resources to send a feedback signal associated with a high throughput PDSCH. The apparatus transmits the feedback signal associated with the high throughput PDSCH in the first PUCCH resource selected from the plurality of PUCCH resources. The apparatus may transmit an offset factor associated with a value for a minimum separation, where the minimum separation is measured in symbols between an end of the high throughput PDSCH and a beginning of the first PUCCH, where the offset factor is applied to a PDSCH processing timeline (N1).

### TECHNICAL FIELD

The present disclosure relates generally to communication systems, and more particularly, to a configuration for reduced power consumption at a user equipment (UE) based on energy efficient scheduling.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a user equipment (UE). The device may be a processor and/or a modem at a UE or the UE itself. The apparatus may receive a scheduling or configuration including at least an indication to operate in a reduced peak throughput state and a plurality of physical uplink control channel (PUCCH) resources. The apparatus may select a first PUCCH resource from the plurality of PUCCH resources to send a feedback signal associated with a high throughput physical downlink shared channel (PDSCH). The apparatus may transmit the feedback signal associated with the high throughput PDSCH in the first PUCCH resource selected from the plurality of PUCCH resources.

In an aspect of the disclosure, a method, a computer-readable medium, and an apparatus are provided. The apparatus may be a device at a network node. The device may be a processor and/or a modem at a network node or the network node itself. The apparatus may provide a scheduling or configuration including at least an indication for a user equipment (UE) to operate in a reduced peak throughput state and a plurality of physical uplink control channel (PUCCH) resources. The apparatus may obtain a feedback signal in a first PUCCH resource from the plurality of PUCCH resources, wherein the feedback signal is associated with a high throughput physical downlink shared channel (PDSCH).

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of scheduling offset.

FIG. 5 is a diagram illustrating an example of a feedback timeline.

FIG. 6 is a diagram illustrating another example of a feedback timeline.

FIG. 7 is a diagram illustrating yet another example of a feedback timeline.

FIG. 8 is a diagram illustrating an example of PDSCH processing time.

FIG. 9 is a diagram illustrating an example of feedback timeline with narrowband scheduling.

FIG. 10 is a call flow diagram of signaling between a UE and a base station.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

FIG. 14 is a flowchart of a method of wireless communication.

FIG. 15 is a flowchart of a method of wireless communication.

FIG. 16 is a diagram illustrating an example of a hardware implementation for an example network entity.

### DETAILED DESCRIPTION

In wireless communications, a minimum gap between a slot having a PDCCH and a slot having a scheduled PDSCH or PUSCH is called a minimum scheduling offset. The minimum time between an end of a PDSCH and a beginning of a corresponding PUCCH is called T_{proc,1} when measured in milliseconds or N₁ when measured in symbols which may be referred to as the PDSCH processing timeline. In some instances, the processing timeline may have a direct impact on K₁. In some instances, the network may prefer operation in a wide bandwidth, high rank, and/or high MCS in an effort to minimize transmission time and reduce network energy consumption or be able to serve more UEs. The UE, however, may assume that it could be scheduled with the maximum throughput, smallest scheduling offset, and the shortest feedback timeline allowed by the configuration, such that the UE may enter or operate in a high-power mode in order to receive or transmit at the peak rate. This high-power mode, may involve a higher clock frequency and generally higher supply voltage to support the higher clock frequency, which may lead to a super-linear increase in power consumption.

In the narrowband (NB) operation mode, the maximum throughput may be limited based on the maximum available bandwidth, such that sustained throughput may be limited. The network may schedule in a first slot and keep the same feedback time as in the narrowband, but the UE might assume that the UE may be scheduled for peak throughput and minimum feedback timeline multiple slots, such that the UE may enter or operate in a high-power mode. While it is the network's interest to schedule the UE with a wide bandwidth, high rank, and/or high MCS to minimize transmission time and reduce network energy consumption, from the UE perspective, the UE does not know that it may only be scheduled with a high power state and may assume that it might be scheduled at peak throughput and minimum feedback timeline.

Aspects presented herein provide a configuration for reduced power consumption at a UE based on energy efficient scheduling. For example, a UE may receive a scheduling from the network that may instruct the UE to operate in a low power RF and baseband state and provide a plurality of PUCCH resources, such that the UE may utilize a first PUCCH resource as a best effort based on the UE capability to process the high throughput PDSCH and provide timely feedback.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

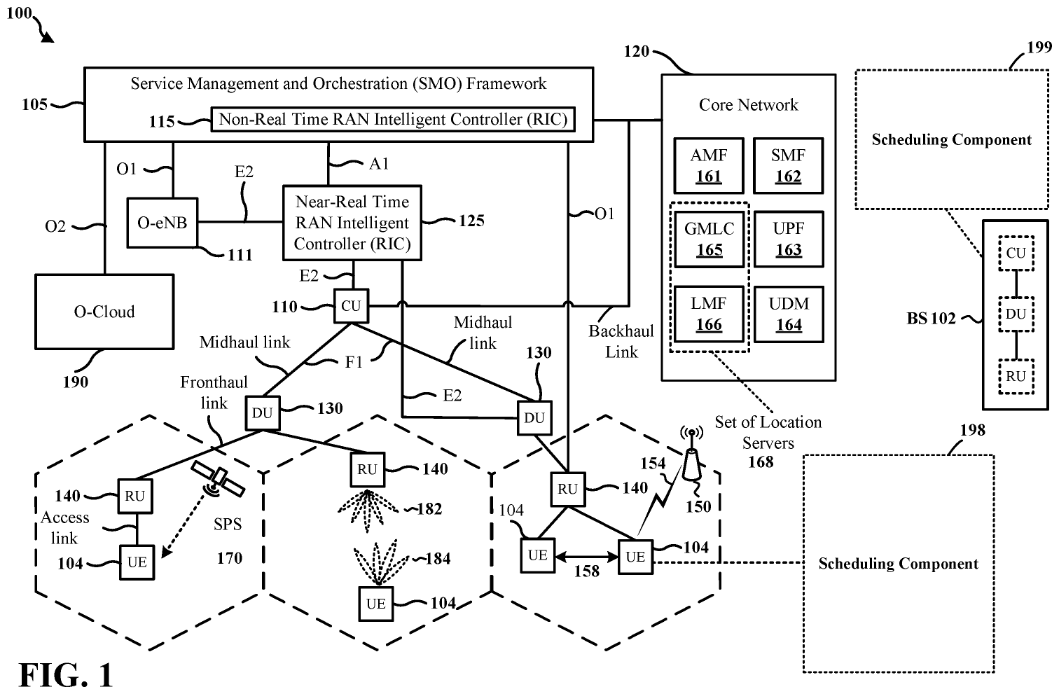

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a scheduling component 198 that may be configured to receive a configuration including at least an indication to operate in a reduced peak throughput state and a plurality of PUCCH resources; select a first PUCCH resource from the plurality of PUCCH resources to send a feedback signal associated with a high throughput PDSCH; and transmit the feedback signal associated with the high throughput PDSCH in the first PUCCH resource selected from the plurality of PUCCH resources.

Referring again to FIG. 1, in certain aspects, the base station 102 may include a scheduling component 199 that may be configured to provide a scheduling or configuration including at least an indication for a UE to operate in a reduced peak throughput and a plurality of PUCCH resources; and obtain a feedback signal in a first PUCCH resource from the plurality of PUCCH resources, wherein the feedback signal is associated with a high throughput PDSCH.

Although the following description may be focused on 5G NR, the concepts described herein may be applicable to other similar areas, such as LTE, LTE-A, CDMA, GSM, and other wireless technologies.

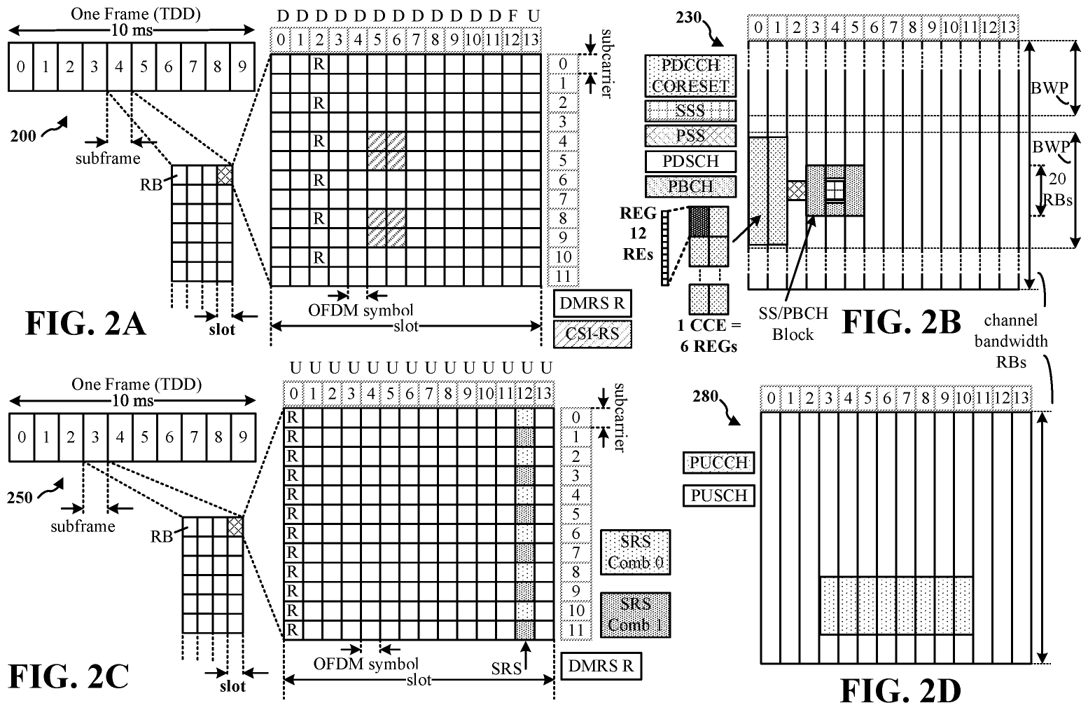

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

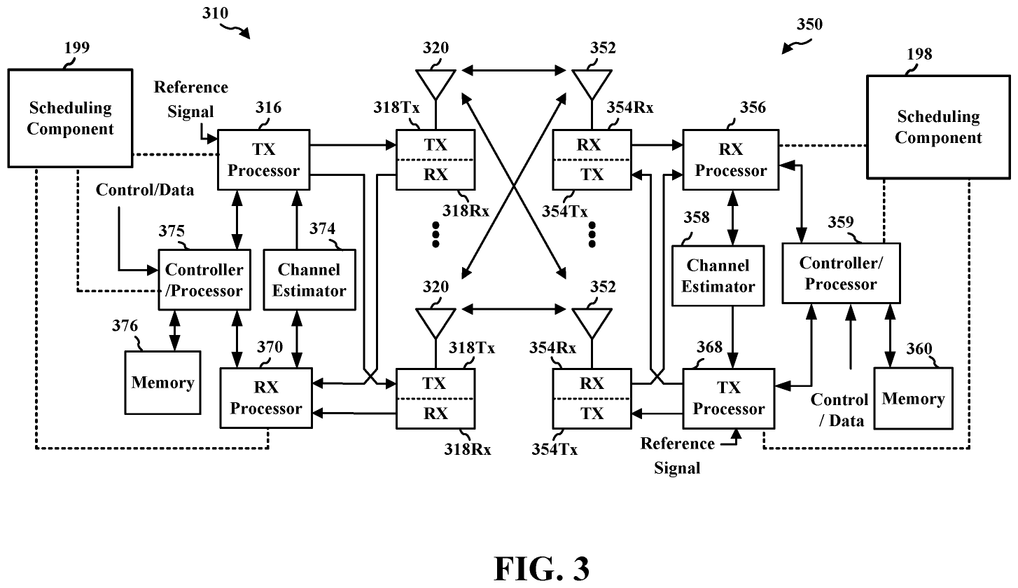

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the scheduling component 198 of FIG. 1.

At least one of the TX processor 316, the RX processor 370, and the controller/processor 375 may be configured to perform aspects in connection with the scheduling component 199 of FIG. 1.

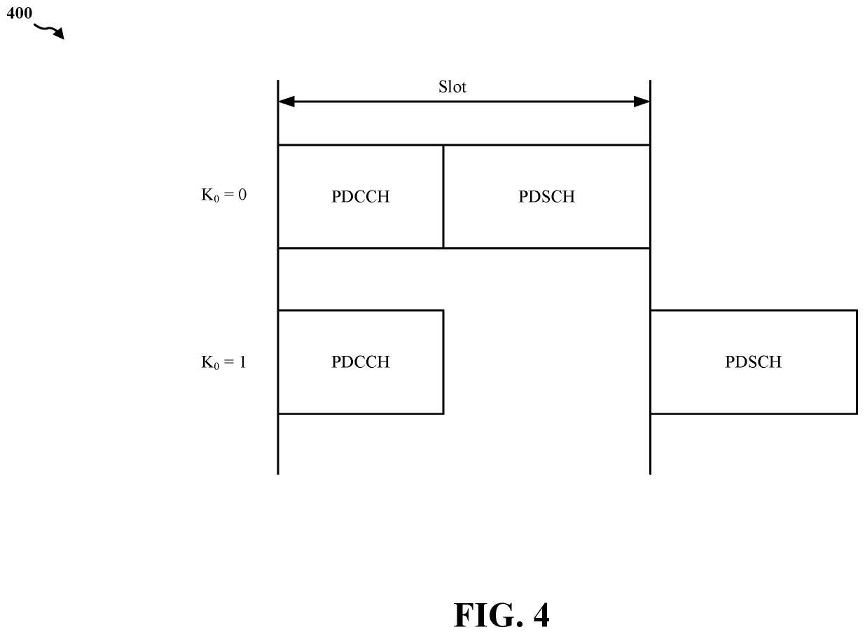

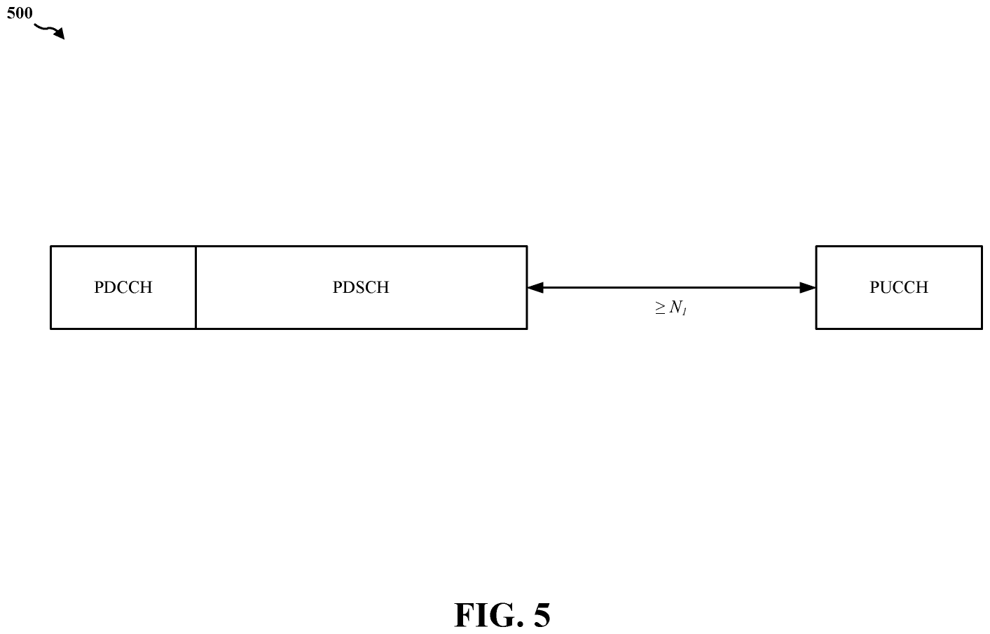

In wireless communications, a minimum gap between a slot having a PDCCH and a slot having a scheduled PDSCH or PUSCH is called a minimum scheduling offset, as shown for example in diagram 400 of FIG. 4. In the example of diagram 400, the gap is denoted K₀ for PDSCH and K₂ for PUSCH. The minimum time between an end of a PDSCH and a beginning of a corresponding PUCCH is called T_{proc,1} when measured in milliseconds or N₁ when measured in symbols. This may be referred to as the PDSCH processing timeline, as shown for example in diagram 500 of FIG. 5. In some instances, the processing timeline may have a direct impact on K₁. In some instances, there may be two PDSCH processing capabilities. For example, a first capability includes a regular processing capability that UEs must support, while a second capability includes a fast-processing capability that UE may optionally support.

In some instances, the network may prefer operation in a wide bandwidth, high rank, and/or high MCS in an effort to minimize transmission time and reduce network energy consumption or be able to serve more UEs. This may be in addition to serving high throughput data to a single UE. The UE, however, may assume that it could be scheduled with the maximum throughput, smallest scheduling offset, and the shortest feedback timeline allowed by the configuration, such that the UE may enter or operate in a high-power mode in order to receive or transmit at the peak rate. This high-power mode, may involve a higher clock frequency and generally higher supply voltage to support the higher clock frequency, which may lead to a super-linear increase in power consumption.

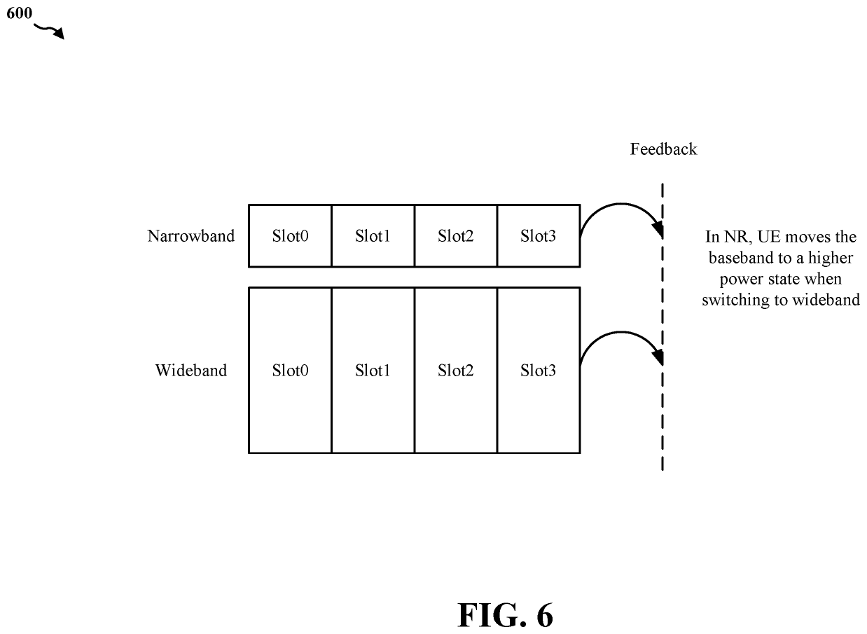

In the narrowband (NB) operation mode, the maximum throughput may be limited based on the maximum available bandwidth, such that sustained throughput may be limited. Similarly, the amount data to decode given a minimum processing timeline (e.g., feedback timeline) may be limited by the bandwidth available for scheduling, for example in Slot 3 as shown in diagram 600 of FIG. 6. In such instances, instantaneous throughput may be limited. In the example of diagram 600 of FIG. 6 which may include wideband (WB) operation mode, the network may schedule in Slot 0 and keep the same feedback time as in the narrowband. However, the UE may not know that the network only schedule in Slot 0 and wants to keep the same feedback time as in the narrowband, and may assume that the UE may be scheduled at peak throughput and minimum feedback timeline in each of Slots 0, 1, 2, and 3. As a result, in such instances, the UE may enter or operate in a high-power mode.

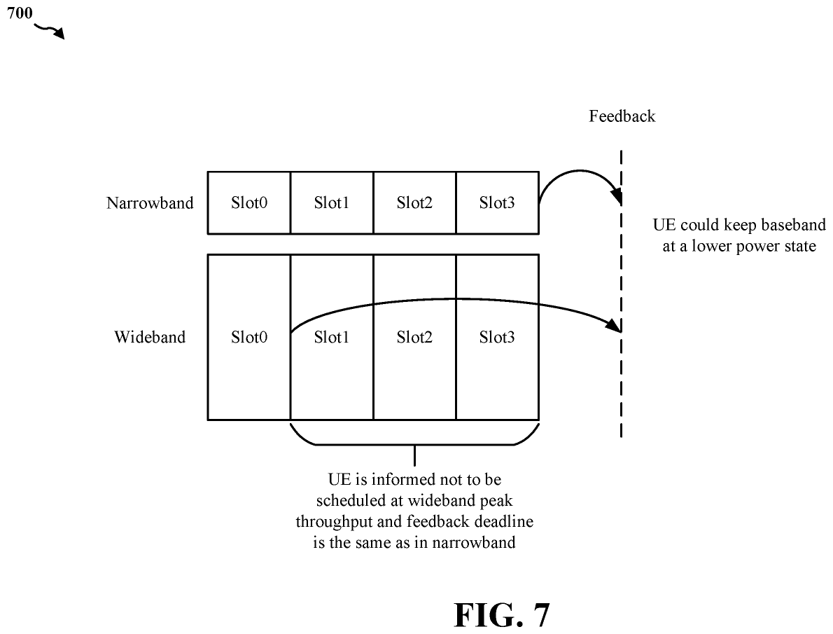

In some instances, as shown for example in diagram 700 of FIG. 7, where the network indicates to the UE at least one of a maximum schedulable sustained throughput being lower than the peak throughput possible given the current configuration, or a minimum data processing (or feedback) timeline being larger than the minimum possible value reported by the UE, then the network may provide such indication to the UE in multiple different manners. For example, the network may provide the indication in at least one of part of an RRC configuration or reconfiguration, when the bandwidth is changed, when the maximum number of MIMO layers is changed, when the maximum modulation order, code rate, MCS, or MCS table is changed, when a bandwidth part (or a configuration profile) is switched, or when cells are activated/deactivated. The network may inform the UE that the UE is not scheduled at wideband peak throughput, and that the feedback deadline is the same as in the narrowband case. In such instances, the UE may keep the baseband at a lower power state.

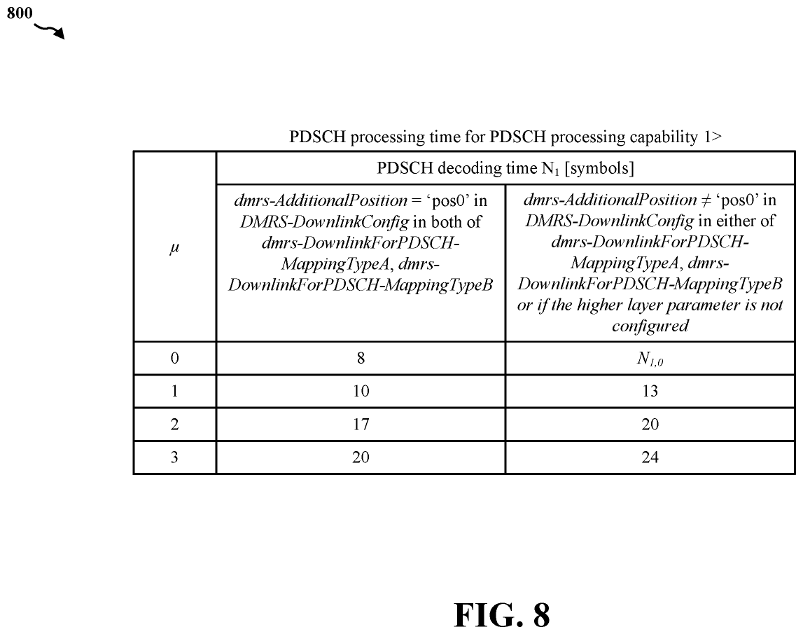

In some instances, RF and baseband operations may contribute to N1 processing timeline. For example, some RF and baseband operations that may contribute to N1 processing timelines may include low noise amplifiers, filters, fast Fourier transfer, analog-to-digital, demodulation, demapper, low-density parity-check decoding, multiple input multiple output blocks, or the like. A relaxing of the N1/N2 processing timeline may impact latency and reliability. For example, a relaxed UE processing timeline in terms of N1 and N2 may impact latency. For downlink transmission, a relaxed N1 value impacts the rate at which HARQ-ACK feedback can be sent after the reception of PDSCH. For uplink transmission, a relaxed N2 value may impact the rate at which PUSCH can be scheduled with respect to the UL grant. The impact on latency may be based on the scheduled number of retransmissions. In addition, a relaxed UE processing timeline in terms of N1 and N2 may allow for processing with a lower clock frequency and lower voltage which may help reducing the UE power consumption. The impact on power consumption of relaxed UE processing time depends on implementation and traffic characteristics, as shown for example in diagram 800 of FIG. 8.

While it is the network's interest to schedule the UE with a wide bandwidth, high rank, and/or high MCS to minimize transmission time and reduce network energy consumption, from the UE perspective, the UE does not know that it may only be scheduled with a high power state for slot 0 only and may assume that it might be scheduled at peak throughput and minimum feedback timeline in each of Slots 0, 1, 2, and 3. The network may provide an indication to the UE that it will not be scheduled for wideband for the next 3 slots, such that the UE would not have to ramp up clock to finish decoding quickly and provide feedback with a tight deadline. However, to obtain the benefit for power and latency, the feedback may be further optimized at the best extent of the UE's new N1 processing capability without assuming worst case scenario (e.g., resembling that of narrowband transmission) since, it is of best interest from latency and reliability point of view to transmit the PUCCH as soon as possible. In some instances, after the network indicates that the UE will not be scheduled with wideband peak throughput, there is a new N1, and a new N1 will result in a new K1.

Aspects presented herein provide a configuration for reduced power consumption at a UE based on energy efficient scheduling. For example, a UE may receive a scheduling from the network that may instruct the UE to operate in a low power RF and baseband state and provide a plurality of PUCCH resources, such that the UE may utilize a first PUCCH resource as a best effort based on the UE capability to process the high throughput PDSCH and provide timely feedback. At least one advantage of the disclosure is that the UE may be configured to provide a feedback response at an increased rate which may allow for faster retransmissions.

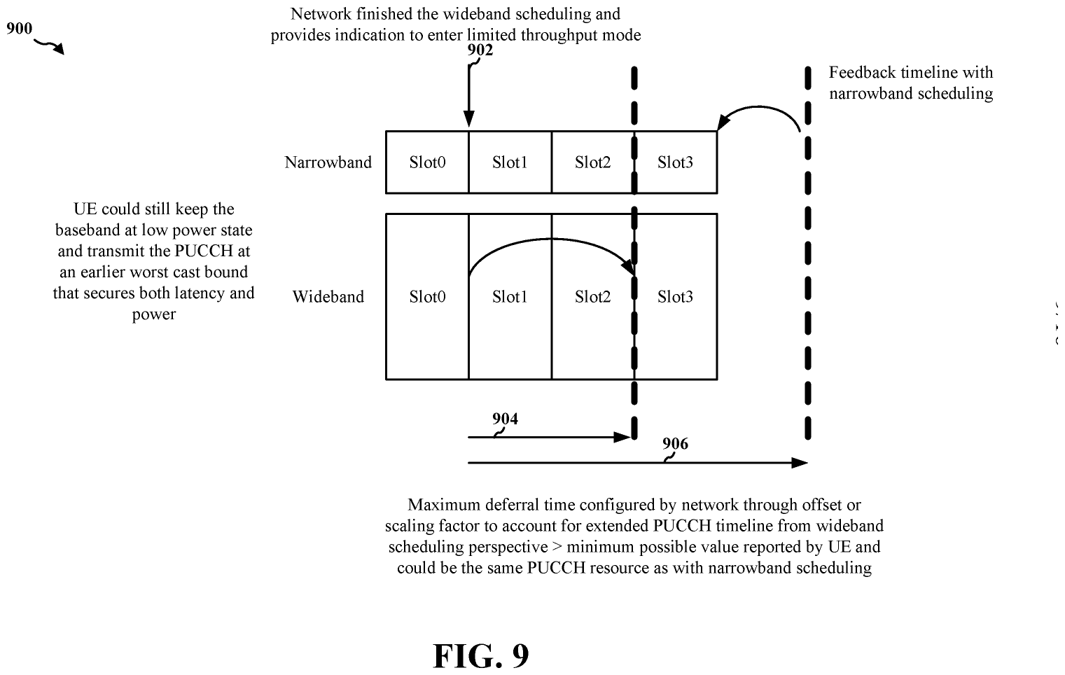

In some aspects, as shown for example in diagram 900 of FIG. 9, the network may indicate to the UE to enter a limited or reduced throughput mode (e.g., at 902), in whichever container that is, the network may then provide in the same container that provides the indication of limited throughput mode, multiple PUCCH resources (e.g., 904, 906). The UE may use a first PUCCH 904 as a best effort based on the UE capabilities to process a high throughput PDSCH associated with the PUCCH and provide timely feedback. This may allow the UE to provide a faster best effort ACK/NACK for faster retransmissions.

In some aspects, as shown for example in diagram 900 of FIG. 9, the UE may receive an indication from network indicating that the UE will not be scheduled at peak throughput mode or to enter the limited throughput mode (e.g., at 902). The UE may consider receipt of such indication as a triggering event. After the UE finishes processing the PDSCH, ideally without having to ramp up clock to finish decoding quickly, the UE may utilize a first PUCCH 904, earliest in time, (e.g., best effort PUCCH) from a maximum deferral time 906 (e.g., worst case PUCCH if narrowband scheduling), provided that the PUCCH resource in the target slot is sufficient for the codebook.

In some aspects, the network may indicate to the UE to enter the limited throughput mode. In such aspects, the network may indicate a subset of PUCCH resources from the plurality of PUCCH resources, where the subset of PUCCH resources may be associated with the scheduled PDSCH. For example, the subset of PUCCH resources may include two or more PUCCH resources associated with the scheduled PDSCH. In such instances, a first PUCCH resource from the subset of PUCCH resources may be used by the UE to transmit a NACK-only in an effort to reduce the retransmission latency, while a second PUCCH resource may be used by the UE to transmit an ACK and/or other potential UCI payload. At least one advantage is an increase to the PUCCH decoding reliability. For example, a two state PUCCH decoder (e.g., ACK discontinuous transmission (DTX) detection and/or NACK-DTX detection) has higher reliability than a three state PUCCH decoder (e.g., ACK-DTX-NACK detection).

In some aspects, the UE may receive an indication from the network indicating the UE to enter or operate in the low power mode (in an aim to keep the baseband at low power). In such aspects, the UE may consider receipt of such indication as a triggering event and provides an offset or scaling factor associated with a previous value of the N1. In some aspects, the UE may provide the offset or scaling factor in uplink signaling such as in uplink MAC-CE. The network may subsequently schedule the PUCCH accordingly with the new N1 and new K1. In some aspects, the same or different offset may be indicated for K1.

In some aspects, the network may provide the UE with a mapping configuration between a throughput scaling and a linear offset to be added to N1 in order to relax N1. The mapping configuration may include an equation that provides a mapping between the throughput scaling and the linear offset. The equation may result in a linear offset in a number of symbols or slots that dynamically adapts a first reported N1 PDSCH processing timeline capability. The equation may be a function of one or more of SCS, bandwidth, MCS, or a number of cells activated or deactivated. In some aspects, the equation may include N1 offset=ceil [f (delta(BW), MCS, Rank, number of cells, etc.)], where the new N1=N1+N1 offset. N1 initial may be the semi-static UE capability of the previous N1.

In some aspects, obtaining the equation of the mapping configuration may be difficult. In such instances, the equation may be trained then shared as part of a semi-static or dynamic capability. In some aspects, the equation may be trained using AI/ML to fit coefficients. In some aspects, the coefficients may be indicated by the UE. In some aspects, the equation may also account for or be associated with one or more of a burst transmission, UE memory, battery status, clock, or the like. The UE may apply a delta to the equation within a specified range to account for any additional UE processing. In some aspects, the network may control the bounds of the UE specific offset by setting the minimum and maximum values. In some aspects, if the network provides an indication of a maximum schedulable sustained throughput in DCI, the UE may provide an offset in UCI in the next available uplink symbols after receiving the DCI in order to provide the network with the offset. In some aspects, if the network provides the indication in downlink MAC-CE, the UE may indicate the offset in MAC-CE and apply the offset after a period of time. In some aspects, the UE may apply the offset after 3 msec. In some aspects, the period of time in which the UE applies the offset may be less than or greater than 3 msec, such that the disclosure is not intended to be limited to the aspects presented herein.

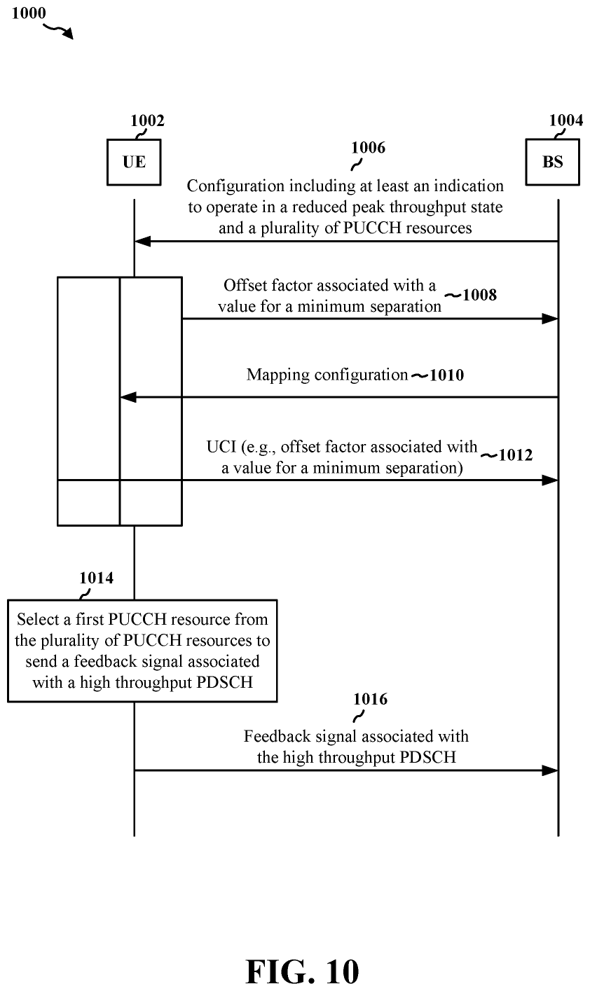

FIG. 10 is a call flow diagram 1000 of signaling between a UE 1002 and a base station 1004. The base station 1004 may be configured to provide at least one cell. The UE 1002 may be configured to communicate with the base station 1004. For example, in the context of FIG. 1, the base station 1004 may correspond to base station 102 and the UE 1002 may correspond to at least UE 104. In another example, in the context of FIG. 3, the base station 1004 may correspond to base station 310 and the UE 1002 may correspond to UE 350.

At 1006, the base station 1004 may provide a scheduling or configuration including at least an indication for a UE to operate in a reduced peak throughput state and a plurality of PUCCH resources. The base station 1004 may provide the scheduling or configuration to the UE 1002. The UE may receive the scheduling or configuration from the base station. The indication to operate in the reduced peak throughput state may include a lower power consumption state that may be based on at least one of DCI, MAC-CE, or RRC. In some aspects, the indication may be part of BWP switching. In some aspects, the indication is not necessarily an explicit RF/BB mode of operation but rather an indication of reduced peak throughput state. The indication may inform the UE that the UE may not be scheduled slots/symbols after the wideband PDSCH. In some aspects, the reduced peak throughput state may include a high RF state and a low baseband state, wherein the UE operates at a highest possible RF state corresponding to a widest possible bandwidth and a reduced baseband state where a maximum peak throughput is unsustained by the UE. The highest possible RF state may correspond to the widest bandwidth and the reduced or lowest baseband state that corresponds to a state at which the UE is indicated that a maximum throughput is not sustained. In some aspects, the reduced baseband state is a state that is reduced in comparison to the highest baseband state. The reduced baseband state may allow the UE to operate at a favorable baseband state that may not be the highest baseband state. In some aspects, the scheduling or configuration may include a narrowband scheduling or a wideband scheduling. In some aspects, the scheduling or configuration may indicate a subset of PUCCH resources from the plurality of PUCCH resources associated with the high throughput PDSCH. For example, the scheduling or configuration may indicate that a first PUCCH resource from the subset of PUCCH resources may be utilized for the UE to transmit a NACK of the feedback signal in an effort to reduce a retransmission latency, while a second PUCCH resource from the subset of PUCCH resources may be utilized for the UE to transmit an ACK of the feedback signal and other potential UCI payloads.

At 1008, the UE 1002 may the UE may transmit an offset factor associated with a value for a minimum separation in response to receipt of the indication to enter the reduced peak throughput state. The UE may transmit the offset factor to the base station 1004. The base station may obtain the offset factor from the UE. The offset factor may be applied to a PDSCH processing timeline (N1). In some aspects, the minimum separation may be measured in symbols between an end of the high throughput PDSCH and a beginning of the first PUCCH.

At 1010, the base station 1004 may provide a mapping configuration between a throughput scaling and an offset factor associated with a value for a minimum separation. The base station may provide the mapping configuration to the UE 1002. The UE may receive the mapping configuration from the base station. The mapping configuration may result in a linear offset that is applied to a first reported value for the minimum separation. In some aspects, the minimum separation may be measured in symbols between an end of the high throughput PDSCH and a beginning of the first PUCCH. In some aspects, the mapping configuration may be associated with at least one of a burst transmission, memory, a battery status, a clock, wherein the offset factor is adjustable based on UE processing. In some aspects, the mapping configuration may include a minimum and a maximum value of the linear offset.

At 1012, the UE may transmit a UCI including an offset factor associated with a value for a minimum separation. The UE may transmit the UCI to the base station. The base station may obtain the UCI from the UE. The UE may transmit the UCI in response to the scheduling or configuration including an indication for the UE to operate in a maximum throughput mode. In some aspects, the minimum separation may be measured in symbols between an end of the high throughput PDSCH and a beginning of the first PUCCH.

At 1014, the UE 1002 may select a first PUCCH resource from the plurality of PUCCH resources to send a feedback signal associated with a high throughput PDSCH. In some aspects, the first PUCCH resource from the plurality of PUCCH resources may be an earliest PUCCH from a maximum deferral time.

At 1016, the UE 1002 may transmit the feedback signal associated with the high throughput PDSCH. The UE may transmit the feedback signal to the base station 1004. The base station may obtain the feedback signal from the UE. The UE may transmit the feedback signal associated with the high throughput PDSCH in the first PUCCH resource selected from the plurality of PUCCH resources. In some aspects, the feedback signal may include the NACK or the ACK.

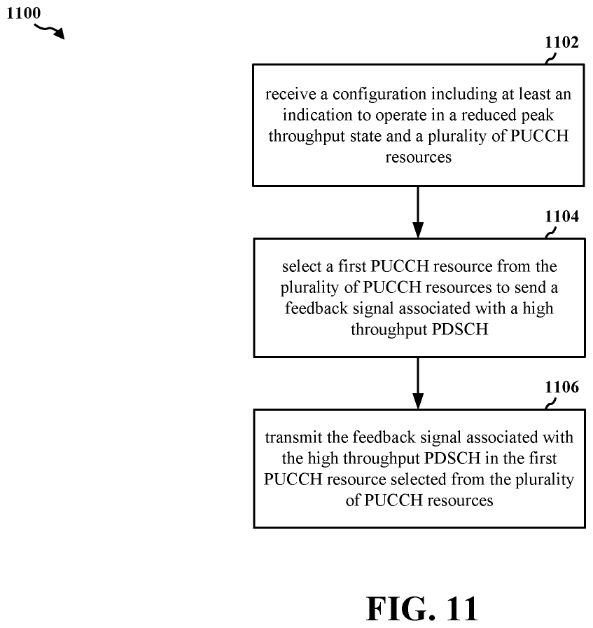

FIG. 11 is a flowchart 1100 of a method of wireless communication. The method may be performed by a UE (e.g., the UE 104; the apparatus 1304). One or more of the illustrated operations may be omitted, transposed, or contemporaneous. The method may configure a UE to operate with reduced power consumption based on energy efficient scheduling.

At 1102, the UE may receive a scheduling or configuration including at least an indication to operate in a reduced peak throughput state and a plurality of PUCCH resources. For example, 1102 may be performed by scheduling component 198 of apparatus 1304. The indication to operate in the reduced peak throughput state may include a lower power consumption state that may be based on at least one of DCI, MAC-CE, or RRC. In some aspects, the indication may be part of BWP switching. In some aspects, the indication is not necessarily an explicit RF/BB mode of operation but rather an indication of reduced peak throughput state. The indication may inform the UE that the UE may not be scheduled slots/symbols after the wideband PDSCH. In some aspects, the reduced peak throughput state may include a high RF state and a low baseband state, wherein the UE operates at a highest possible RF state corresponding to a widest possible bandwidth and a reduced baseband state where a maximum peak throughput is unsustained by the UE. The highest possible RF state may correspond to the widest bandwidth and the reduced or lowest baseband state that corresponds to a state at which the UE is indicated that a maximum throughput is not sustained. In some aspects, the reduced baseband state is a state that is reduced in comparison to the highest baseband state. The reduced baseband state may allow the UE to operate at a favorable baseband state that may not be the highest baseband state. In some aspects, the scheduling or configuration may include a narrowband scheduling or a wideband scheduling. In some aspects, the scheduling or configuration may indicate a subset of PUCCH resources from the plurality of PUCCH resources associated with the high throughput PDSCH. For example, the scheduling or configuration may indicate that a first PUCCH resource from the subset of PUCCH resources may be utilized for the UE to transmit a non-acknowledgement (NACK) of the feedback signal in an effort to reduce a retransmission latency, while a second PUCCH resource from the subset of PUCCH resources may be utilized for the UE to transmit an acknowledgement (ACK) of the feedback signal and other potential UCI payloads.

At 1104, the UE may select a first PUCCH resource from the plurality of PUCCH resources. For example, 1104 may be performed by scheduling component 198 of apparatus 1304. The UE may select the first PUCCH resource from the plurality of PUCCH resources to send a feedback signal associated with a high throughput PDSCH. In some aspects, the first PUCCH resource from the plurality of PUCCH resources may be an earliest PUCCH from a maximum deferral time.

At 1106, the UE may transmit the feedback signal associated with the high throughput PDSCH. For example, 1106 may be performed by scheduling component 198 of apparatus 1304. The UE may transmit the feedback signal associated with the high throughput PDSCH in the first PUCCH resource selected from the plurality of PUCCH resources. In some aspects, the feedback signal may include the NACK or the ACK.

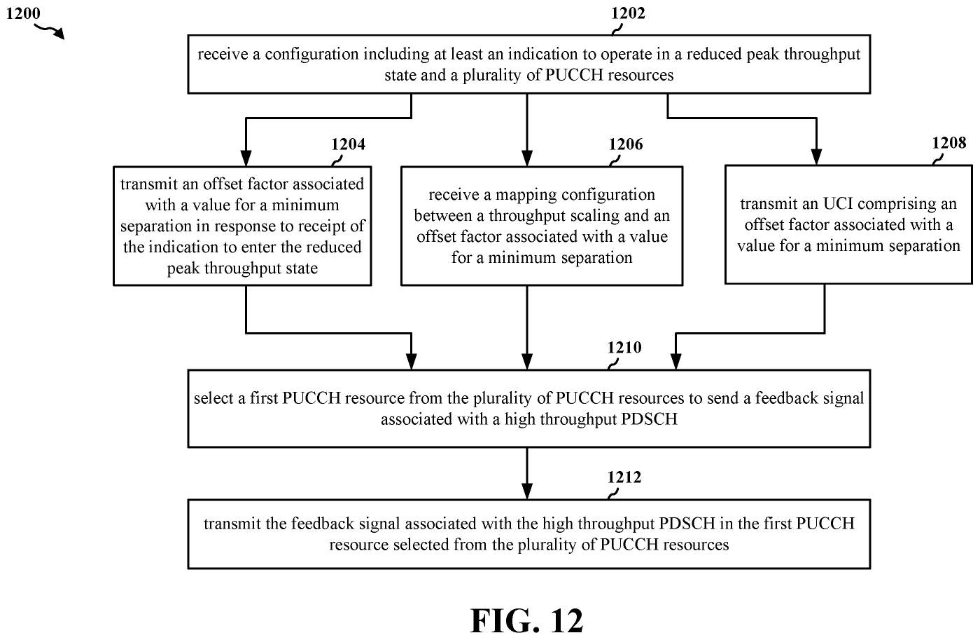

FIG. 12 is a flowchart 1200 of a method of wireless communication. The method may be performed by a UE (e.g., the UE 104; the apparatus 1304). One or more of the illustrated operations may be omitted, transposed, or contemporaneous. The method may configure a UE to operate with reduced power consumption based on energy efficient scheduling.

At 1202, the UE may receive a scheduling or configuration including at least an indication to operate in a reduced peak throughput state and a plurality of PUCCH resources. For example, 1202 may be performed by scheduling component 198 of apparatus 1304. The indication to operate in the reduced peak throughput state may include a lower power consumption state that may be based on at least one of DCI, MAC-CE, or RRC. In some aspects, the indication may be part of BWP switching. In some aspects, the indication is not necessarily an explicit RF/BB mode of operation but rather an indication of reduced peak throughput state. The indication may inform the UE that the UE may not be scheduled slots/symbols after the wideband PDSCH. In some aspects, the reduced peak throughput state may include a high RF state and a low baseband state, wherein the UE operates at a highest possible RF state corresponding to a widest possible bandwidth and a reduced baseband state where a maximum peak throughput is unsustained by the UE. The highest possible RF state may correspond to the widest bandwidth and the reduced or lowest baseband state that corresponds to a state at which the UE is indicated that a maximum throughput is not sustained. In some aspects, the reduced baseband state is a state that is reduced in comparison to the highest baseband state. The reduced baseband state may allow the UE to operate at a favorable baseband state that may not be the highest baseband state. In some aspects, the scheduling or configuration may include a narrowband scheduling or a wideband scheduling. In some aspects, the scheduling or configuration may indicate a subset of PUCCH resources from the plurality of PUCCH resources associated with the high throughput PDSCH. For example, the scheduling or configuration may indicate that a first PUCCH resource from the subset of PUCCH resources may be utilized for the UE to transmit a NACK of the feedback signal in an effort to reduce a retransmission latency, while a second PUCCH resource from the subset of PUCCH resources may be utilized for the UE to transmit an ACK of the feedback signal and other potential UCI payloads.

At 1204, the UE may transmit an offset factor. For example, 1204 may be performed by scheduling component 198 of apparatus 1304. The offset factor may be associated with a value for a minimum separation in response to receipt of the indication to enter the reduced peak throughput state. The offset factor may be applied to a PDSCH processing timeline (N1). In some aspects, the minimum separation may be measured in symbols between an end of the high throughput PDSCH and a beginning of the first PUCCH.

At 1206, the UE may receive a mapping configuration between a throughput scaling and an offset factor associated with a value for a minimum separation. For example, 1206 may be performed by scheduling component 198 of apparatus 1304. The mapping configuration may result in a linear offset that is applied to a first reported value for the minimum separation. In some aspects, the minimum separation may be measured in symbols between an end of the high throughput PDSCH and a beginning of the first PUCCH. In some aspects, the mapping configuration may be associated with at least one of a burst transmission, memory, a battery status, a clock, wherein the offset factor is adjustable based on UE processing. In some aspects, the mapping configuration may include a minimum and a maximum value of the linear offset.

At 1208, the UE may transmit a UCI. For example, 1208 may be performed by scheduling component 198 of apparatus 1304. The UCI may include an offset factor associated with a value for a minimum separation. The UE may transmit the UCI in response to the scheduling or configuration including an indication for the UE to operate in a maximum throughput mode. In some aspects, the minimum separation may be measured in symbols between an end of the high throughput PDSCH and a beginning of the first PUCCH.

At 1210, the UE may select a first PUCCH resource from the plurality of PUCCH resources. For example, 1210 may be performed by scheduling component 198 of apparatus 1304. The UE may select the first PUCCH resource from the plurality of PUCCH resources to send a feedback signal associated with a high throughput PDSCH. In some aspects, the first PUCCH resource from the plurality of PUCCH resources may be an earliest PUCCH from a maximum deferral time.

At 1212, the UE may transmit the feedback signal associated with the high throughput PDSCH. For example, 1212 may be performed by scheduling component 198 of apparatus 1304. The UE may transmit the feedback signal associated with the high throughput PDSCH in the first PUCCH resource selected from the plurality of PUCCH resources. In some aspects, the feedback signal may include the NACK or the ACK.

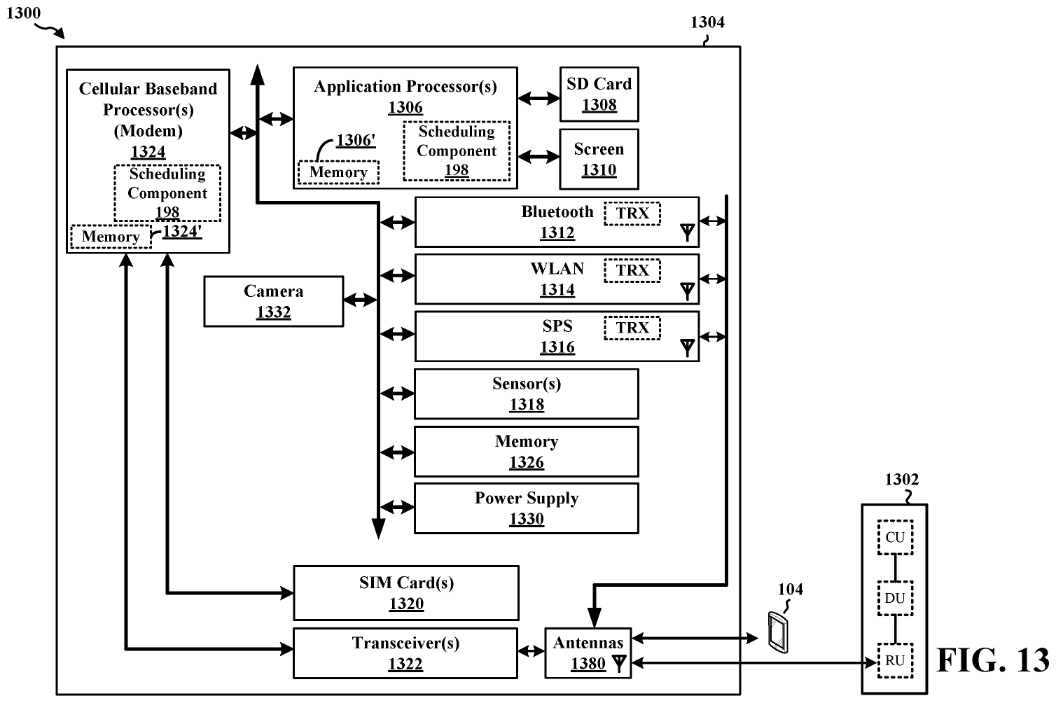

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) 1324 communicates through the transceiver(s) 1322 via one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The cellular baseband processor(s) 1324 and the application processor(s) 1006 are configured to perform the various functions described supra based at least in part of the information stored in the memory. That is, the cellular baseband processor(s) 1324 and the application processor(s) 1306 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the component 198 may be configured to receive a configuration including at least an indication to operate in a reduced peak throughput state and a plurality of PUCCH resources; select a first PUCCH resource from the plurality of PUCCH resources to send a feedback signal associated with a high throughput PDSCH; and transmit the feedback signal associated with the high throughput PDSCH in the first PUCCH resource selected from the plurality of PUCCH resources. The component 198 may be within the cellular baseband processor(s) 1324, the application processor(s) 1306, or both the cellular baseband processor(s) 1324 and the application processor(s) 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for receiving a configuration including at least an indication to operate in a reduced peak throughput state and a plurality of PUCCH resources. The apparatus includes means for selecting a first PUCCH resource from the plurality of PUCCH resources to send a feedback signal associated with a high throughput PDSCH. The apparatus includes means for transmitting the feedback signal associated with the high throughput PDSCH in the first PUCCH resource selected from the plurality of PUCCH resources. The apparatus further includes means for transmitting an offset factor associated with a value for a minimum separation in response to receipt of the indication to enter the reduced peak throughput state, wherein the minimum separation is measured in symbols between an end of the high throughput PDSCH and a beginning of the first PUCCH, wherein the offset factor is applied to a PDSCH processing timeline (N1). The apparatus further includes means for receiving a mapping configuration between a throughput scaling and an offset factor associated with a value for a minimum separation, wherein the mapping configuration results in a linear offset that is applied to a first reported value for the minimum separation, wherein the minimum separation is measured in symbols between an end of the high throughput PDSCH and a beginning of the first PUCCH. The apparatus further includes means for transmitting an uplink control indication (UCI) comprising an offset factor associated with a value for a minimum separation, wherein the minimum separation is measured in symbols between an end of the high throughput PDSCH and a beginning of the first PUCCH. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

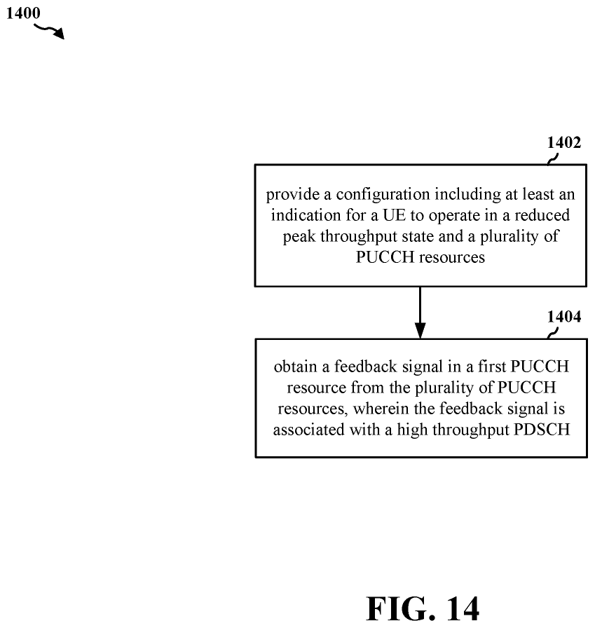

FIG. 14 is a flowchart 1400 of a method of wireless communication. The method may be performed by a base station (e.g., the base station 102; the network entity 1302, 1602). One or more of the illustrated operations may be omitted, transposed, or contemporaneous. The method may configure a UE to operate with reduced power consumption based on energy efficient scheduling.

At 1402, the network entity may provide a configuration including at least an indication for a UE to operate in a reduced peak throughput state and a plurality of PUCCH resources. For example, 1402 may be performed by scheduling component 199 of network entity 1602. In some aspects, the reduced peak throughput state may include a high RF state and a low baseband state, wherein the UE operates at a highest possible RF state corresponding to a widest possible bandwidth and a reduced baseband state where a maximum peak throughput is unsustained by the UE. The highest possible RF state may correspond to the widest bandwidth and the reduced or lowest baseband state that corresponds to a state at which the UE is indicated that a maximum throughput is not sustained. In some aspects, the reduced baseband state is a state that is reduced in comparison to the highest baseband state. The reduced baseband state may allow the UE to operate at a favorable baseband state that may not be the highest baseband state. In some aspects, the scheduling or configuration may include a narrowband scheduling or a wideband scheduling. In some aspects, the scheduling or configuration may indicate a subset of PUCCH resources from the plurality of PUCCH resources associated with the high throughput PDSCH. For example, the scheduling or configuration may indicate that a first PUCCH resource from the subset of PUCCH resources may be utilized for the UE to transmit a NACK of the feedback signal in an effort to reduce a retransmission latency, while a second PUCCH resource from the subset of PUCCH resources may be utilized for the UE to transmit an ACK of the feedback signal and other potential UCI payloads.

At 1404, the network entity may obtain a feedback signal in a first PUCCH resource from the plurality of PUCCH resources. For example, 1404 may be performed by scheduling component 199 of network entity 1602. The feedback signal may be associated with a high throughput PDSCH. In some aspects, the feedback signal comprises a NACK or an ACK. In some aspects, the first PUCCH resource from the plurality of PUCCH resources is an earliest PUCCH from a maximum deferral time.

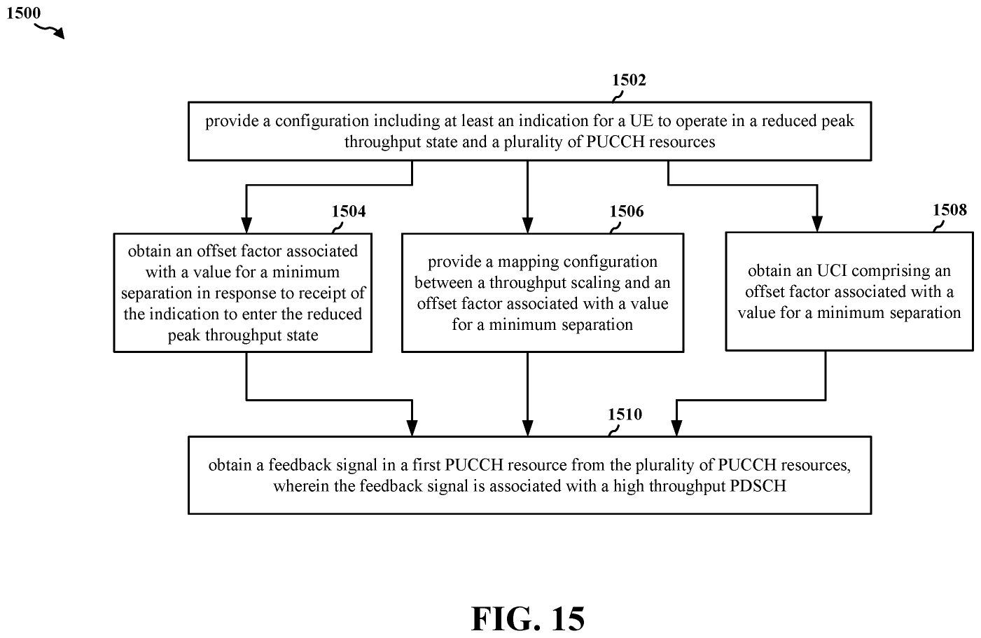

FIG. 15 is a flowchart 1500 of a method of wireless communication. The method may be performed by a base station (e.g., the base station 102; the network entity 1302, 1602). One or more of the illustrated operations may be omitted, transposed, or contemporaneous. The method may configure a UE to operate with reduced power consumption based on energy efficient scheduling.

At 1502, the network entity may provide a scheduling or configuration including at least an indication for a UE to operate in a reduced peak throughput state and a plurality of PUCCH resources. For example, 1502 may be performed by scheduling component 199 of network entity 1602. In some aspects, the reduced peak throughput state may include a high RF state and a low baseband state, wherein the UE operates at a highest possible RF state corresponding to a widest possible bandwidth and a reduced baseband state where a maximum peak throughput is unsustained by the UE. The highest possible RF state may correspond to the widest bandwidth and the reduced or lowest baseband state that corresponds to a state at which the UE is indicated that a maximum throughput is not sustained. In some aspects, the reduced baseband state is a state that is reduced in comparison to the highest baseband state. The reduced baseband state may allow the UE to operate at a favorable baseband state that may not be the highest baseband state. In some aspects, the scheduling or configuration may include a narrowband scheduling or a wideband scheduling. In some aspects, the scheduling or configuration may indicate a subset of PUCCH resources from the plurality of PUCCH resources associated with the high throughput PDSCH. For example, the scheduling or configuration may indicate that a first PUCCH resource from the subset of PUCCH resources may be utilized for the UE to transmit a NACK of the feedback signal in an effort to reduce a retransmission latency, while a second PUCCH resource from the subset of PUCCH resources may be utilized for the UE to transmit an ACK of the feedback signal and other potential UCI payloads.

At 1504, the network entity may obtain an offset factor. For example, 1504 may be performed by scheduling component 199 of network entity 1602. The offset factor may be associated with a value for a minimum separation in response to receipt of the indication to enter the reduced peak throughput state by the UE. The offset factor may be applied to a PDSCH processing timeline (N1). In some aspects, the minimum separation may be measured in symbols between an end of the high throughput PDSCH and a beginning of the first PUCCH.

At 1506, the network entity may provide a mapping configuration between a throughput scaling and an offset factor associated with a value for a minimum separation. For example, 1506 may be performed by scheduling component 199 of network entity 1602. The mapping configuration may result in a linear offset that is applied to a first reported value for the minimum separation. In some aspects, the minimum separation may be measured in symbols between an end of the high throughput PDSCH and a beginning of the first PUCCH. In some aspects, the mapping configuration may be associated with at least one of a burst transmission, memory, a battery status, a clock, wherein the offset factor is adjustable based on UE processing. In some aspects, the mapping configuration may include a minimum and a maximum value of the linear offset.

At 1508, the network entity may obtain a UCI. For example, 1508 may be performed by scheduling component 199 of network entity 1602. The UCI may include an offset factor associated with a value for a minimum separation. The network entity may obtain the UCI from the UE in response to the scheduling or configuration including an indication for the UE to operate in a maximum throughput mode. In some aspects, the minimum separation may be measured in symbols between an end of the high throughput PDSCH and a beginning of the first PUCCH.

At 1510, the network entity may obtain a feedback signal in a first PUCCH resource from the plurality of PUCCH resources. For example, 1510 may be performed by scheduling component 199 of network entity 1602. The feedback signal may be associated with a high throughput PDSCH. In some aspects, the feedback signal comprises a NACK or an ACK. In some aspects, the first PUCCH resource from the plurality of PUCCH resources is an earliest PUCCH from a maximum deferral time

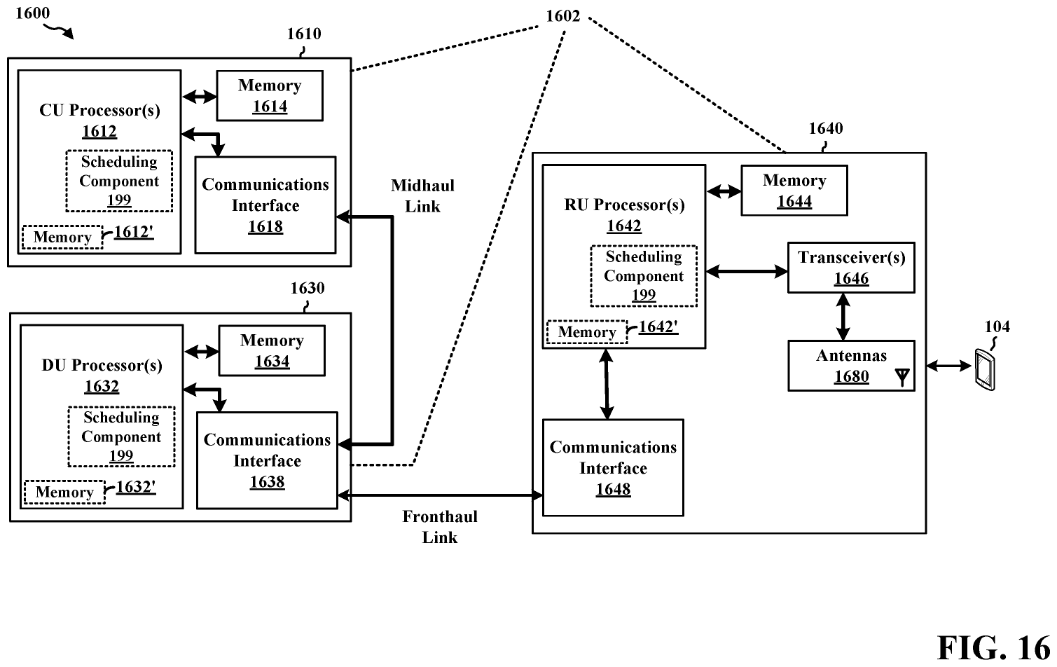

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide a configuration including at least an indication for a UE to operate in a reduced peak throughput state and a plurality of PUCCH resources; and obtain a feedback signal in a first PUCCH resource from the plurality of PUCCH resources, wherein the feedback signal is associated with a high throughput PDSCH. The component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for providing a configuration including at least an indication for a UE to operate in a reduced peak throughput state and a plurality of PUCCH resources. The network entity includes means for obtaining a feedback signal in a first PUCCH resource from the plurality of PUCCH resources, wherein the feedback signal is associated with a high throughput PDSCH. The network entity further includes means for obtaining an offset factor associated with a value for a minimum separation in response to receipt of the indication to enter the reduced peak throughput state, wherein the minimum separation is measured in symbols between an end of the high throughput PDSCH and a beginning of the first PUCCH, wherein the offset factor is applied to a PDSCH processing timeline (N1). The network entity further includes means for providing a mapping configuration between a throughput scaling and an offset factor associated with a value for a minimum separation, wherein the mapping configuration results in a linear offset that is applied to a first reported value for the minimum separation, wherein the minimum separation is measured in symbols between an end of the high throughput PDSCH and a beginning of the first PUCCH. The network entity further includes means for obtaining an UCI comprising an offset factor associated with a value for a minimum separation, wherein the minimum separation is measured in symbols between an end of the high throughput PDSCH and a beginning of the first PUCCH. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE comprising receiving a configuration including at least an indication to operate in a reduced peak throughput state and a plurality of PUCCH resources; selecting a first PUCCH resource from the plurality of PUCCH resources to send a feedback signal associated with a high throughput PDSCH; and transmitting the feedback signal associated with the high throughput PDSCH in the first PUCCH resource selected from the plurality of PUCCH resources.

Aspect 2 is the method of aspect 1, further includes that the reduced peak throughput state comprises a high RF state and a low baseband state, wherein the UE operates at a highest possible RF state corresponding to a widest possible bandwidth and a reduced baseband state where a maximum peak throughput is unsustained by the UE.

Aspect 3 is the method of any of aspects 1 and 2, further includes that the feedback signal comprises a NACK or an ACK.

Aspect 4 is the method of any of aspects 1-3, further includes that the configuration comprises a narrowband scheduling or a wideband scheduling.

Aspect 5 is the method of any of aspects 1-4, further includes that the first PUCCH resource from the plurality of PUCCH resources is an earliest PUCCH from a maximum deferral time.

Aspect 6 is the method of any of aspects 1-5, further includes that the configuration indicates a subset of PUCCH resources from the plurality of PUCCH resources associated with the high throughput PDSCH.

Aspect 7 is the method of any of aspects 1-6, further includes that a first PUCCH from the subset of PUCCH resources is utilized for transmission of a NACK of the feedback signal, wherein a second PUCCH from the subset of PUCCH resources is utilized for transmission of an ACK of the feedback signal.

Aspect 8 is the method of any of aspects 1-7, further including transmitting an offset factor associated with a value for a minimum separation in response to receipt of the indication to enter the reduced peak throughput state, wherein the minimum separation is measured in symbols between an end of the high throughput PDSCH and a beginning of the first PUCCH, wherein the offset factor is applied to a PDSCH processing timeline (N1).

Aspect 9 is the method of any of aspects 1-8, further including receiving a mapping configuration between a throughput scaling and an offset factor associated with a value for a minimum separation, wherein the mapping configuration results in a linear offset that is applied to a first reported value for the minimum separation, wherein the minimum separation is measured in symbols between an end of the high throughput PDSCH and a beginning of the first PUCCH.

Aspect 10 is the method of any of aspects 1-9, further includes that the mapping configuration is associated with at least one of a burst transmission, memory, a battery status, a clock, wherein the offset factor is adjustable based on UE processing.

Aspect 11 is the method of any of aspects 1-10, further includes that the mapping configuration comprises a minimum and a maximum value of the linear offset.

Aspect 12 is the method of any of aspects 1-11, further includes that the configuration comprises the indication to enter a maximum throughput mode, further including transmitting an UCI comprising an offset factor associated with a value for a minimum separation, wherein the minimum separation is measured in symbols between an end of the high throughput PDSCH and a beginning of the first PUCCH.

Aspect 13 is an apparatus for wireless communication at a UE including at least one processor coupled to a memory and at least one transceiver, the at least one processor configured to implement any of aspects 1-12.

Aspect 14 is an apparatus for wireless communication at a UE including means for implementing any of aspects 1-12.

Aspect 15 is a computer-readable medium storing computer executable code, where the code when executed by a processor causes the processor to implement any of aspects 1-12.

Aspect 16 is a method of wireless communication at a network entity comprising providing a configuration including at least an indication for a UE to operate in a reduced peak throughput state and a plurality of PUCCH resources; and obtaining a feedback signal in a first PUCCH resource from the plurality of PUCCH resources, wherein the feedback signal is associated with a high throughput PDSCH.

Aspect 17 is the method of aspect 16, further includes that the reduced peak throughput state comprises a high RF state and a low baseband state, wherein the UE operates at a highest possible RF state corresponding to a widest possible bandwidth and a reduced baseband state where a maximum peak throughput is unsustained by the UE.

Aspect 18 is the method of any of aspects 16 and 17, further includes that the feedback signal comprises a NACK or an ACK.

Aspect 19 is the method of any of aspects 16-18, further includes that the configuration comprises a narrowband scheduling or a wideband scheduling.

Aspect 20 is the method of any of aspects 16-19, further includes that the first PUCCH resource from the plurality of PUCCH resources is an earliest PUCCH from a maximum deferral time.

Aspect 21 is the method of any of aspects 16-20, further includes that the configuration indicates a subset of PUCCH resources from the plurality of PUCCH resources associated with the high throughput PDSCH.

Aspect 22 is the method of any of aspects 16-21, further includes that a first PUCCH from the subset of PUCCH resources is utilized for transmission of a NACK of the feedback signal, wherein a second PUCCH from the subset of PUCCH resources is utilized for transmission of an ACK of the feedback signal.

Aspect 23 is the method of any of aspects 16-22, further including obtaining an offset factor associated with a value for a minimum separation in response to receipt of the indication to enter the reduced peak throughput state by the UE, wherein the minimum separation is measured in symbols between an end of the high throughput PDSCH and a beginning of the first PUCCH, wherein the offset factor is applied to a PDSCH processing timeline (N1).

Aspect 24 is the method of any of aspects 16-23, further including providing a mapping configuration between a throughput scaling and an offset factor associated with a value for a minimum separation, wherein the mapping configuration results in a linear offset that is applied to a first reported value for the minimum separation, wherein the minimum separation is measured in symbols between an end of the high throughput PDSCH and a beginning of the first PUCCH.

Aspect 25 is the method of any of aspects 16-24, further includes that the mapping configuration is associated with at least one of a burst transmission, memory, a battery status, a clock, wherein the offset factor is adjustable based on UE processing.

Aspect 26 is the method of any of aspects 16-25, further includes that the mapping configuration comprises a minimum and a maximum value of the linear offset.

Aspect 27 is the method of any of aspects 16-26, further includes that the configuration comprises the indication to enter a maximum throughput mode, further including obtaining an uplink control indication (UCI) comprising an offset factor associated with a value for a minimum separation, wherein the minimum separation is measured in symbols between an end of the high throughput PDSCH and a beginning of the first PUCCH.

Aspect 28 is an apparatus for wireless communication at a network entity including at least one processor coupled to a memory and at least one transceiver, the at least one processor configured to implement any of aspects 15-25.

Aspect 29 is an apparatus for wireless communication at a network entity including means for implementing any of aspects 15-25.

Aspect 30 is a computer-readable medium storing computer executable code, where the code when executed by a processor causes the processor to implement any of aspects 15-25.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the apparatus to:
receive a configuration including at least an indication to operate in a reduced peak throughput state and a plurality of physical uplink control channel (PUCCH) resources;
select a first PUCCH resource from the plurality of PUCCH resources to send a feedback signal associated with a high throughput physical downlink shared channel (PDSCH); and
transmit the feedback signal associated with the high throughput PDSCH in the first PUCCH resource selected from the plurality of PUCCH resources.

2. The apparatus of claim 1, further comprising a transceiver coupled to the at least one processor, the transceiver being configured to:
receive the configuration including at least the indication to operate in the reduced peak throughput state and the plurality of PUCCH resources; and
transmit the feedback signal associated with the high throughput PDSCH in the first PUCCH resource selected from the plurality of PUCCH resources.

3. The apparatus of claim 1, wherein the reduced peak throughput state comprises a high radio frequency (RF) state and a low baseband state, wherein the UE operates at a highest possible RF state corresponding to a widest possible bandwidth and a reduced baseband state where a maximum peak throughput is unsustained by the UE.

4. The apparatus of claim 1, wherein the feedback signal comprises a non-acknowledgement (NACK) or an acknowledgement (ACK).

5. The apparatus of claim 1, wherein the configuration comprises a narrowband scheduling or a wideband scheduling.

6. The apparatus of claim 1, wherein the first PUCCH resource from the plurality of PUCCH resources is an earliest PUCCH from a maximum deferral time.

7. The apparatus of claim 1, wherein the configuration indicates a subset of PUCCH resources from the plurality of PUCCH resources associated with the high throughput PDSCH.

8. The apparatus of claim 7, wherein a first PUCCH from the subset of PUCCH resources is utilized for transmission of a non-acknowledgement (NACK) of the feedback signal, wherein a second PUCCH from the subset of PUCCH resources is utilized for transmission of an acknowledgement (ACK) of the feedback signal.

9. The apparatus of claim 1, wherein the at least one processor is configured to:
transmit an offset factor associated with a value for a minimum separation in response to receipt of the indication to enter the reduced peak throughput state, wherein the minimum separation is measured in symbols between an end of the high throughput PDSCH and a beginning of the first PUCCH, wherein the offset factor is applied to a PDSCH processing timeline (N1).

10. The apparatus of claim 1, wherein the at least one processor is configured to:
receive a mapping configuration between a throughput scaling and an offset factor associated with a value for a minimum separation, wherein the mapping configuration results in a linear offset that is applied to a first reported value for the minimum separation, wherein the minimum separation is measured in symbols between an end of the high throughput PDSCH and a beginning of the first PUCCH.

11. The apparatus of claim 10, wherein the mapping configuration is associated with at least one of a burst transmission, memory, a battery status, a clock, wherein the offset factor is adjustable based on UE processing.

12. The apparatus of claim 10, wherein the mapping configuration comprises a minimum and a maximum value of the linear offset.

13. The apparatus of claim 1, wherein the configuration comprises the indication to enter a maximum throughput mode, wherein the at least one processor is configured to:
transmit an uplink control indication (UCI) comprising an offset factor associated with a value for a minimum separation, wherein the minimum separation is measured in symbols between an end of the high throughput PDSCH and a beginning of the first PUCCH.

14. A method of wireless communication at a user equipment (UE), comprising:
receiving a configuration including at least an indication to operate in a reduced peak throughput state and a plurality of physical uplink control channel (PUCCH) resources;
selecting a first PUCCH resource from the plurality of PUCCH resources to send a feedback signal associated with a high throughput physical downlink shared channel (PDSCH); and
transmitting the feedback signal associated with the high throughput PDSCH in the first PUCCH resource selected from the plurality of PUCCH resources.

15. The method of claim 14, further comprising:
transmitting an offset factor associated with a value for a minimum separation in response to receipt of the indication to enter the reduced peak throughput state, wherein the minimum separation is measured in symbols between an end of the high throughput PDSCH and a beginning of the first PUCCH, wherein the offset factor is applied to a PDSCH processing timeline (N1).

16. An apparatus for wireless communication at a network entity, comprising:
at least one memory; and
at least one processor coupled to the at least one memory and, based at least in part on information stored in the at least one memory, the at least one processor, individually or in any combination, is configured to cause the apparatus to:
provide a configuration including at least an indication for a user equipment (UE) to operate in a reduced peak throughput state and a plurality of physical uplink control channel (PUCCH) resources; and
obtain a feedback signal in a first PUCCH resource from the plurality of PUCCH resources, wherein the feedback signal is associated with a high throughput physical downlink shared channel (PDSCH).

17. The apparatus of claim 16, further comprising a transceiver coupled to the at least one processor, the transceiver being configured to:
provide the configuration including at least the indication for the UE to operate in the reduced peak throughput state and the plurality of PUCCH resources; and
obtain the feedback signal in the first PUCCH resource from the plurality of PUCCH resources, wherein the feedback signal is associated with the high throughput PDSCH.

18. The apparatus of claim 16, wherein the reduced peak throughput state comprises a high radio frequency (RF) state and a low baseband state, wherein the UE operates at a highest possible RF state corresponding to a widest possible bandwidth and a reduced baseband state where a maximum peak throughput is unsustained by the UE.

19. The apparatus of claim 16, wherein the feedback signal comprises a non-acknowledgement (NACK) or an acknowledgement (ACK).

20. The apparatus of claim 16, wherein the configuration comprises a narrowband scheduling or a wideband scheduling.

21. The apparatus of claim 16, wherein the first PUCCH resource from the plurality of PUCCH resources is an earliest PUCCH from a maximum deferral time.

22. The apparatus of claim 16, wherein the configuration indicates a subset of PUCCH resources from the plurality of PUCCH resources associated with the high throughput PDSCH.

23. The apparatus of claim 22, wherein a first PUCCH from the subset of PUCCH resources is utilized for transmission of a non-acknowledgement (NACK) of the feedback signal, wherein a second PUCCH from the subset of PUCCH resources is utilized for transmission of an acknowledgement (ACK) of the feedback signal.

24. The apparatus of claim 16, wherein the at least one processor is configured to:
obtain an offset factor associated with a value for a minimum separation in response to receipt of the indication to enter the reduced peak throughput state by the UE, wherein the minimum separation is measured in symbols between an end of the high throughput PDSCH and a beginning of the first PUCCH, wherein the offset factor is applied to a PDSCH processing timeline (N1).

25. The apparatus of claim 16, wherein the at least one processor is configured to:
provide a mapping configuration between a throughput scaling and an offset factor associated with a value for a minimum separation, wherein the mapping configuration results in a linear offset that is applied to a first reported value for the minimum separation, wherein the minimum separation is measured in symbols between an end of the high throughput PDSCH and a beginning of the first PUCCH.

26. The apparatus of claim 25, wherein the mapping configuration is associated with at least one of a burst transmission, memory, a battery status, a clock, wherein the offset factor is adjustable based on UE processing.

27. The apparatus of claim 25, wherein the mapping configuration comprises a minimum and a maximum value of the linear offset.

28. The apparatus of claim 16, wherein the configuration comprises the indication to enter a maximum throughput mode, wherein the at least one processor is configured to:
obtain an uplink control indication (UCI) comprising an offset factor associated with a value for a minimum separation, wherein the minimum separation is measured in symbols between an end of the high throughput PDSCH and a beginning of the first PUCCH.

29. A method of wireless communication at a network entity, comprising:
providing a configuration including at least an indication for a user equipment (UE) to operate in a reduced peak throughput state and a plurality of physical uplink control channel (PUCCH) resources; and
obtaining a feedback signal in a first PUCCH resource from the plurality of PUCCH resources, wherein the feedback signal is associated with a high throughput physical downlink shared channel (PDSCH).

30. The method of claim 29, further comprising:
obtaining an offset factor associated with a value for a minimum separation in response to receipt of the indication to enter the reduced peak throughput state, wherein the minimum separation is measured in symbols between an end of the high throughput PDSCH and a beginning of the first PUCCH, wherein the offset factor is applied to a PDSCH processing timeline (N1).
